(19) United States
(12) Patent Application Publication
(10) Pub. No.: US 2025/0390682 A1
(43) Pub. Date: Dec. 25, 2025

(54) Hierarchical Audio Generators and Codecs for Enhanced Audio Generation

(71) Applicant: Mitsubishi Electric Research Laboratories, Inc., Cambridge, MA (US)

(72) Inventors: Sameer Khurana, Brookline, MA (US); Jonathan Le Roux, Arlington, MA (US); Gordon Wichern, Boston, MA (US); Chiori Hori, Lexington, MA (US); François G Germain, Boston, MA (US); Janek Ebbers, Boston, MA (US); Kohei Saijo, Boston, MA (US); Amir Hussein, Boston, MA (US)

(73) Assignee: Mitsubishi Electric Research Laboratories, Inc., Cambridge, MA (US)

(21) Appl. No.: 18/945,894

(22) Filed: Nov. 13, 2024

Related U.S. Application Data
(60) Provisional application No. 63/661,951, filed on Jun. 20, 2024.

(51) Int. Cl. G06F 40/35

(52) U.S. Cl. CPC G06F 40/35

(57) ABSTRACT

Systems, methods, software, and devices are disclosed herein process context data to encode one or more semantic elements of a desired audio composition in a semantic token sequence, process the semantic token sequence to encode one or more structural elements of the desired audio composition in a structural token sequence disentangled from the semantic token sequence, and process the structural token sequence to encode one or more audio signal elements of the desired audio composition in an audio signal token sequence disentangled from the structural token sequence. The semantic token sequence, the structural token sequence, and the audio signal token sequence may then be processed to generate at least a portion of the desired audio composition.

### TECHNICAL FIELD

Aspects of the disclosure are related to the field of audio processing, and in particular, to generative audio technology.

### BACKGROUND

Audio generation refers to the process of creating audio content using computational methods, often through machine learning models. This can include generating music, speech, sound effects, and other types of audio. Techniques for audio generation range from traditional signal processing methods to advanced neural networks such as UniAudio, AudioLM, and other types of generative artificial intelligence. Applications of audio generation include text-to-speech systems, music composition, voice synthesis, and more.

At a high level, audio generation using Large Language Models (LLMs) involves converting audio into a sequence of tokens that represent various aspects of the audio, such as phonemes, acoustic features, or semantic content. The LLMs are then trained on the token sequences such that they can be prompted to generate new token sequences that, when converted back into audio waveforms, produce coherent and high-quality audio outputs.

UniAudio tokenizes target audio along with other condition modalities such as phoneme sequences and textual descriptions. The tokens are then concatenated into a single sequence, which the model processes to perform next-token prediction. Thus, UniAudio conditions low-level code generation directly on context, meaning that the audio signal tokens that are produced are generated based on their preceding audio signal tokens as well as contextualized tokens concatenated with the preceding audio signal tokens.

Other approaches involve hierarchical modeling, where the model first generates a rough outline of the audio (semantic tokens) and then refines it into detailed acoustic tokens. For example, AudioLM conditions the low-level codes upon fine-level acoustic details of a waveform, whereas the higher layers involve semantic tokens that capture long-term structure and context. These tokens are derived from intermediate representations of a pre-trained model and they encode the relationships between different sounds and their ordering, ensuring that the generated audio is coherent and contextually appropriate.

### SUMMARY

Technology is disclosed herein that improves the field of audio generation by way of a hierarchical audio encoder that learns a hierarchical and disentangled semantic, structural, and low-level discrete codes or tokens, effectively compressing audio data at different levels of abstraction. The enhanced encoder may then be employed to train a hierarchical code generator that generates audio conditioned on a given context, which can be audio, text, and/or an image.

In an implementation, an audio generation method includes processing context data to encode one or more semantic elements of a desired audio composition in a semantic token sequence, processing the semantic token sequence to encode one or more structural elements of the desired audio composition in a structural token sequence disentangled from the semantic token sequence, and processing the structural token sequence to encode one or more audio signal elements of the desired audio composition in an audio signal token sequence disentangled from the structural token sequence. The semantic token sequence, the structural token sequence, and the audio signal token sequence may then be processed to generate at least a portion of the desired audio composition.

In the same or other implementations, a top-level code generator may be employed to generate the semantic token sequence, a mid-level code generator may be employed to generate the structural token sequence, and a low-level code generator may be employed to generate the audio signal tokens. In addition, or alternatively, a top-level encoder may be employed to train the top-level code generator, a mid-level encoder may be employed to train the mid-level code generator, and a low-level encoder may be employed to train the low-level code generator. The top-level encoder may be conditioned on context data to generate semantic tokens, the mid-level encoder may be conditioned on the semantic tokens (or values related thereto) to generate structural tokens disentangled from the semantic tokens, and the low-level encoder is conditioned on the structural tokens (or values related thereto) to generate audio-signal tokens disentangled from the structural tokens, and thus also from the semantic tokens.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a hierarchical audio generation system and associated operational scenario in an implementation.

FIG. 2 illustrates an audio generation process employed by the system of FIG. 1 in an implementation.

FIG. 3 illustrates another hierarchical audio generation system and a method for training the same in an implementation.

FIG. 4 illustrates a hierarchical audio encoding system and a method for training the same in an implementation.

FIG. 5 illustrates another hierarchical audio generation system and associated operational scenario in an implementation.

FIG. 6A illustrates a semantic layer of a hierarchical audio generation system and a method of training the same in an implementation.

FIG. 6B illustrates a structural layer of a hierarchical audio generation system and a method of training the same an implementation.

FIG. 6C illustrates an audio signal layer of a hierarchical audio generation system and a method of training the same in an implementation.

FIG. 7A illustrates a hierarchical audio encoding system and an associated operational scenario in an implementation.

FIG. 7B illustrates a method of training the hierarchical audio encoding system of

FIG. 7A in an implementation.

FIG. 8 illustrates a computing system suitable for implementing the various operational environments, architectures, processes, scenarios, and sequences discussed below with respect to the other Figures.

### DETAILED DESCRIPTION

The present disclosure relates to a hierarchical codec that compresses audio into discrete codes at three levels of abstraction: top-level semantic codes, mid-level structural codes, and low-level signal codes. The hierarchical codec may be employed to train a hierarchical generator that produces sequences of audio tokens that may be converted to audio wave forms.

An encoding process employed by the hierarchical codec begins with extracting top-level semantic codes using a Vector Quantization (VQ) module, which are conditioned only on the input audio. Mid-level codes are subsequently extracted, conditioned on both the input audio and the top-level codes. Finally, low-level codes are extracted, which are conditioned on the input audio and the mid-level codes. Each level of codes represents different aspects of the audio: the top-level codes capture high-level concepts like genre and mood, the mid-level codes capture structural features such as rhythm patterns and phoneme segmentation, and the low-level codes capture basic signal properties.

The training process of the hierarchical code involves optimizing several loss functions, including a top-level contrastive loss, a mid-level masked-prediction loss, and low-level signal matching losses. This ensures that each layer of the codec effectively captures the intended features at its respective level of abstraction.

Once trained, the hierarchical code is used to construct a hierarchical generator that generates audio conditioned on a given context, which may be audio, text, an image, or the like. The generation process involves producing top-level codes from the context, mid-level codes from the top-level codes, and low-level codes from the mid-level codes, ensuring that the generated audio aligns closely with the provided context.

The disclosed techniques leverage a decoupled hierarchical generative process that enhances scalability, modularity, and robustness. By simplifying the dependencies at each level, the techniques allow each stage to specialize and optimize its encoding and generation process, leading to high-fidelity audio generation.

Additionally, or alternatively, the disclosed techniques include a multimodal encoder trained in a Student-Teacher framework, where the multimodal encoder (student) learns from a pre-trained text encoder (teacher). This multimodal encoder transforms the context into embeddings that condition the top-level code generator, ensuring coherent and contextually appropriate audio generation.

Overall, this disclosure presents a robust system for hierarchical audio compression and generation, capable of handling complex and varied contextual inputs with high fidelity. The generative model presented here can be used for a variety of generation tasks including text-to-speech synthesis, text description to acoustic scene synthesis, text description to music synthesis, spoken image captioning, generating sound effects given a visual scene, spoken language translation, audio inpainting, audio enhancement, audio source separation, and text-queried audio source separation.

The hierarchical encoding and generation techniques disclosed herein provide systems capable of performing different audio generation tasks given a variety of user-provided contexts. At least one technical effect that may be appreciated from the foregoing disclosure lies in its hierarchical and decouple generative process relative to prior solutions such as UniAudio. While UniAudio conditions the low-level code (a1) generator directly on the context (C), the disclosed techniques involve generating top-level semantic codes (a3) conditioned on C, and then generating mid-level (a2) and low-level (a2) codes based on the top-level codes. This method offers several benefits including Layered Abstraction, Scalability and Modularity, Robustness and Error Mitigation, Enhanced Control, and Higher Mutual Information and Sample Efficiency.

Layered Abstraction: By decoupling the generation process, the disclosed models allow each code generator to focus on different levels of abstraction, making the overall generation task easier by breaking it into simpler tasks that each generator can focus on. The top-level codes capture high-level semantic features, the mid-level encapsulate structural details, and the low-level codes represent basic signal characteristics. This hierarchical structure ensures that each code generator specializes in encoding specific types of information, leading to more accurate, and contextually appropriate audio generation.

Scalability and Modularity: Since each code generator operates independently once conditioned on its preceding layer, the models can more easily handle diverse context without extensive re-training. Changes in context would primarily affect the top-level code generator, allowing for modular updates and adaptations without the need to re-train an entire model.

Robustness and Error Mitigation: The hierarchical structure mitigates error propagation, as inaccuracies in the top-level generation can be refined and corrected in subsequent layers. This leads to higher fidelity in the final audio output, with better alignment to the intended semantic, structural, and signal-level characteristics.

Enhanced Control: the disclosed hierarchical generation process provides more control over the generation process. For example, manipulating the top-level semantic codes influences the high-level attributes of the generated audio, such as genre or mood. Similarly, adjustments to the mid-level and low-level codes allow for fine-tuning of structural and signal-level details, respectively. This type of granular and precise control is not possible in UniAudio.

Higher Mutual Information and Sample Efficiency: The mutual information between the context C and the top-level codes (a3) is much higher than between C and the low-level codes (a1). This makes predicting a3 from C significantly easier, potentially leading to more efficient few-shot learning for the top-level code generator p(a3|C). In contrast, learning p(a1|C) directly, as UniAudio does, would require much more data due to lower mutual information and the higher bit complexity of al. Thus, the disclosed techniques are more sample-efficient, requiring less data to achieve effective training compared to UniAudio.

Overall, the disclosed hierarchical approach with a decoupled generative process not only provides a more structured, flexible, and robust solution for audio generation tasks compared to UniAudio but also offers greater control over the generated output and higher sample efficiency. More specifically, whereas some prior techniques can extract only low-level codes a1, which capture basic signal properties such as amplitude, spectral, and temporal characteristics, the disclosed hierarchical codec learns and extracts codes at multiple levels of abstraction. The hierarchical codec compresses audio into top-level semantic codes (a3), which encapsulate high-level concepts like genre, mood, syntax, grammar, etc.; mid-level semantic codes (a2), which encode detailed information about musical instruments, rhythm patterns, intonation, phoneme segmentation, and event durations; and low-level codes (a1), similar to those extracted in prior works. The hierarchical approach allows the hierarchical codec to capture a richer and more comprehensive representation of audio, facilitating more sophisticated and contextually relevant audio compression and generation.

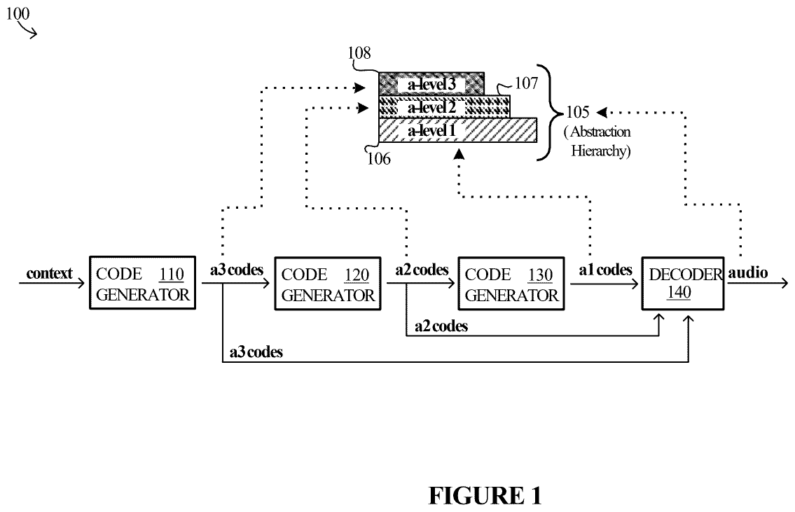

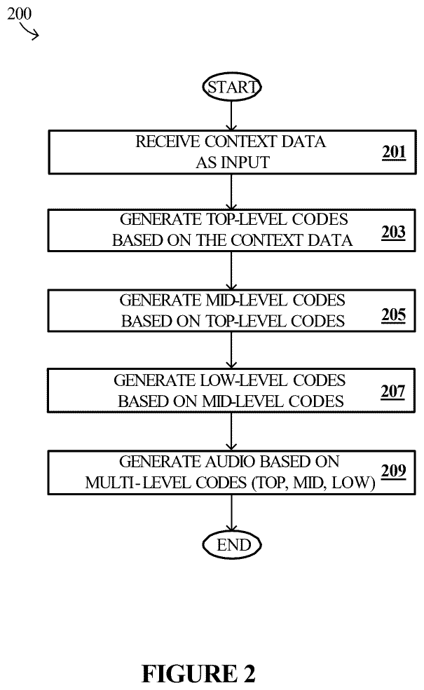

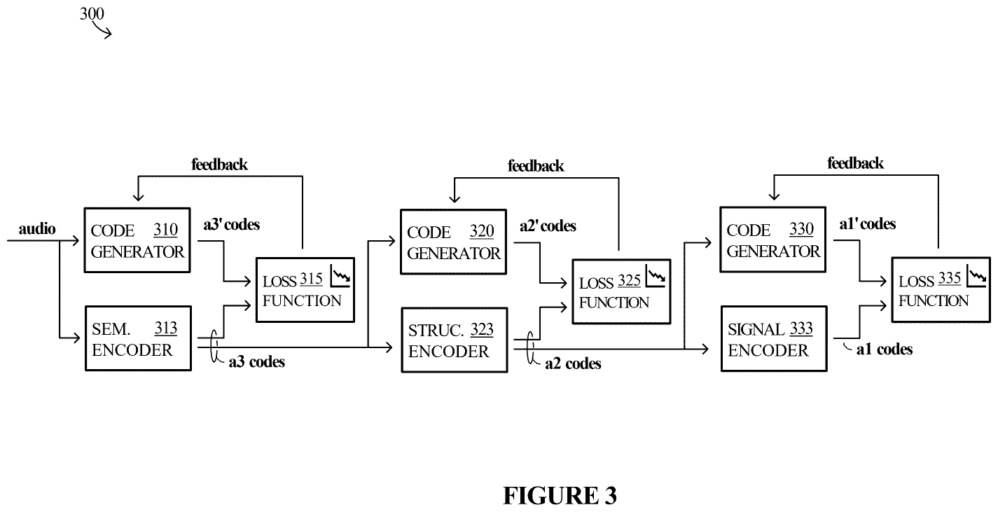

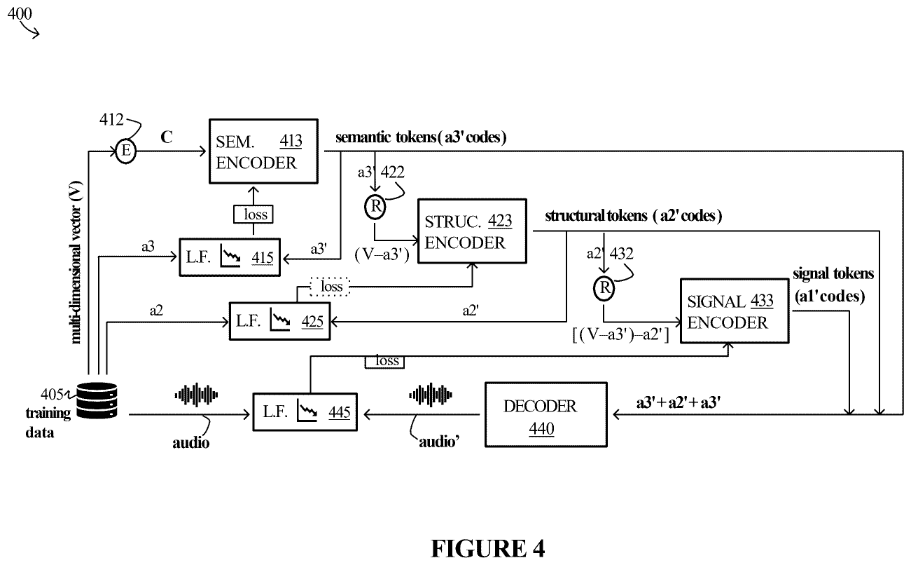

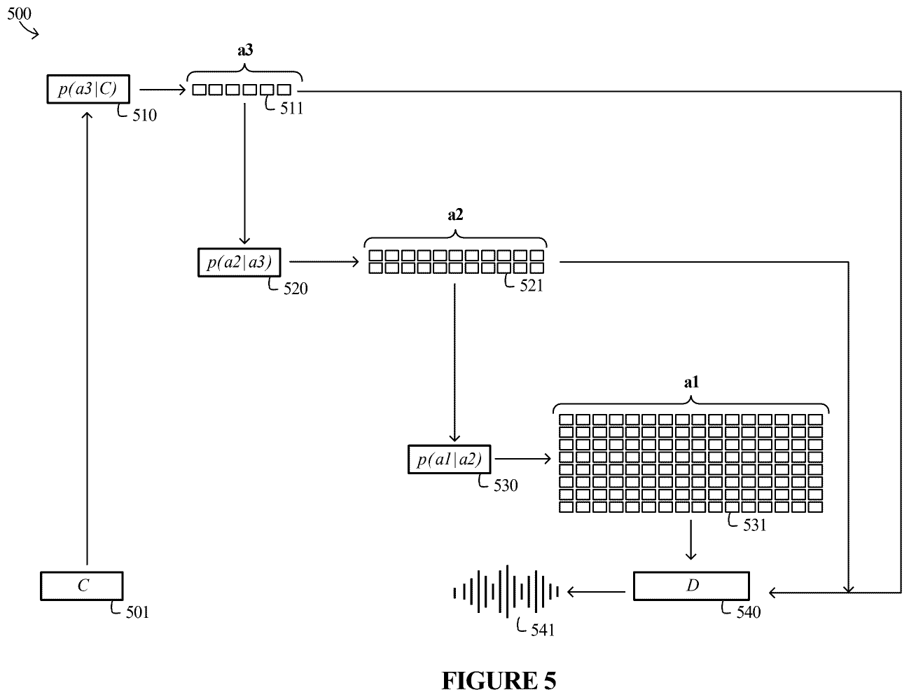

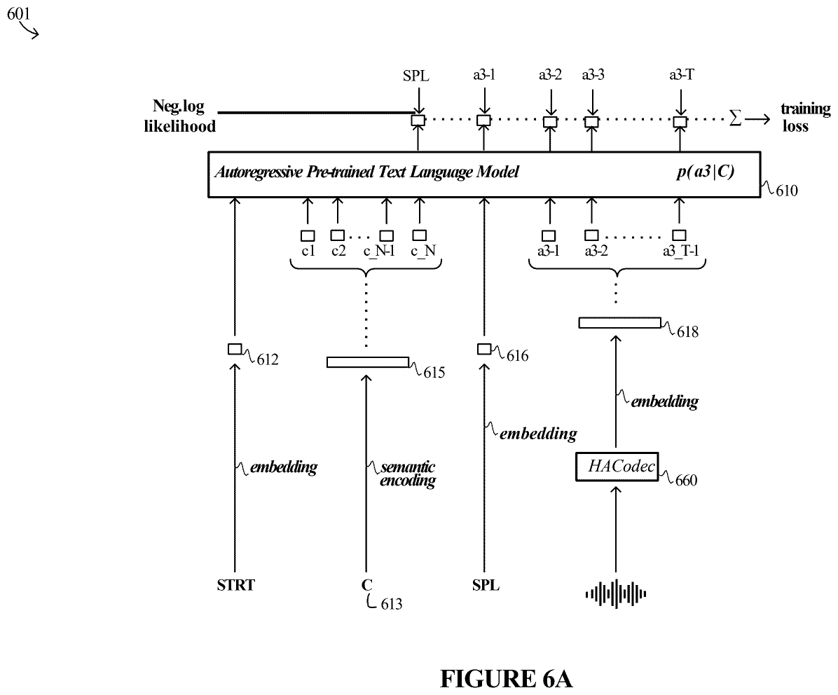

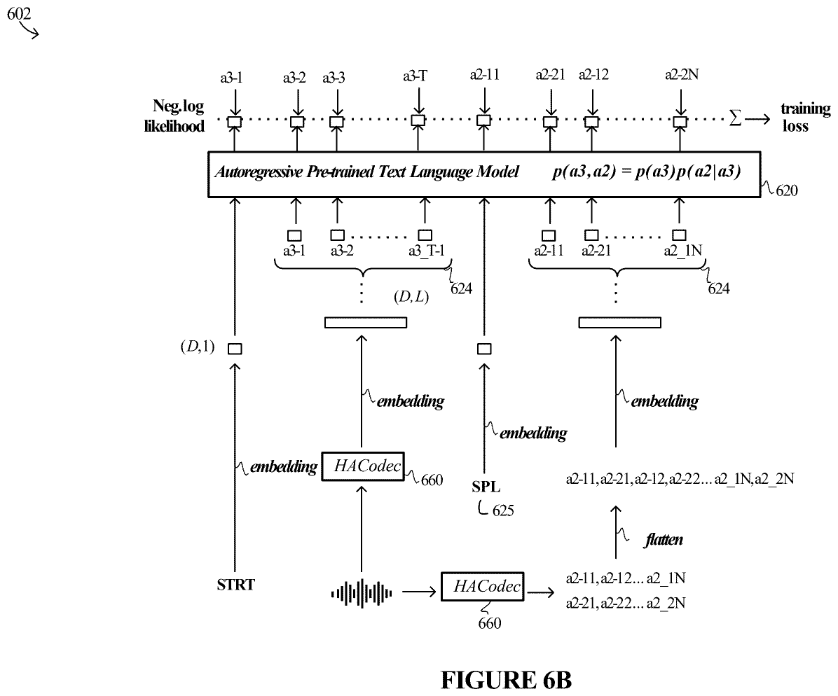

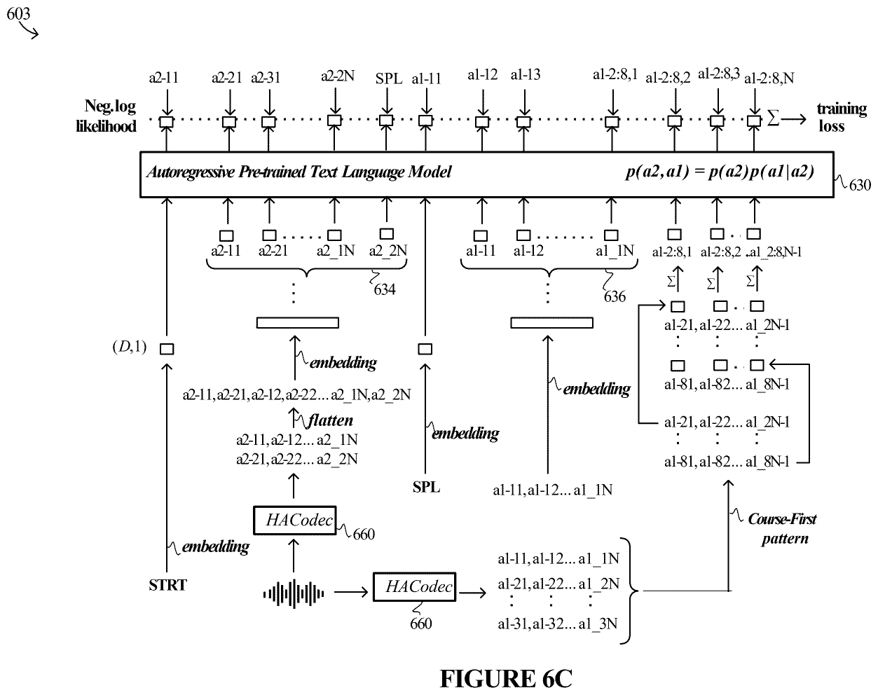

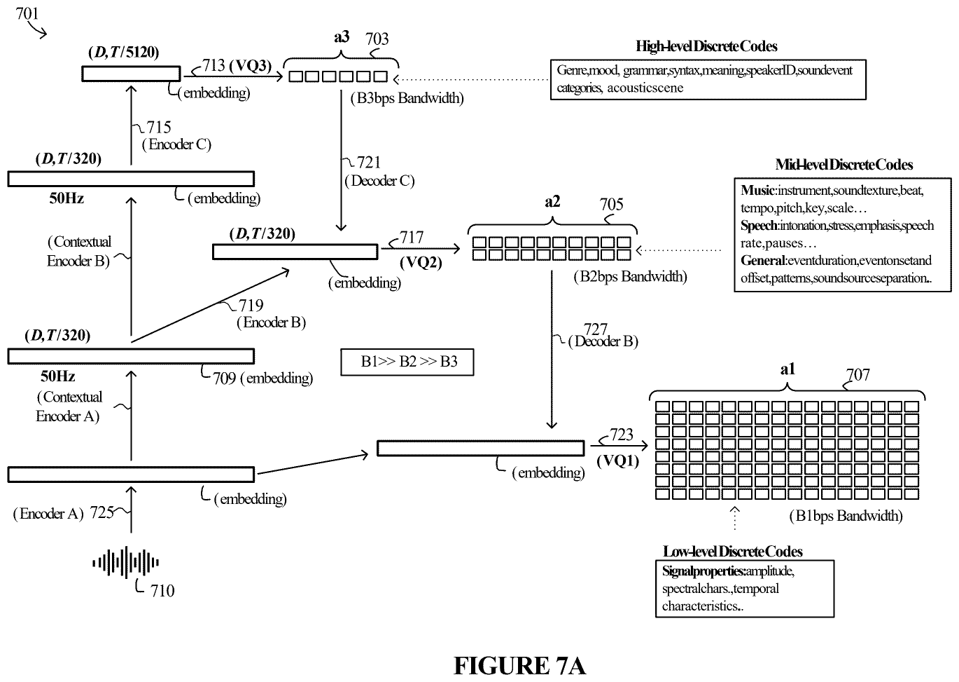

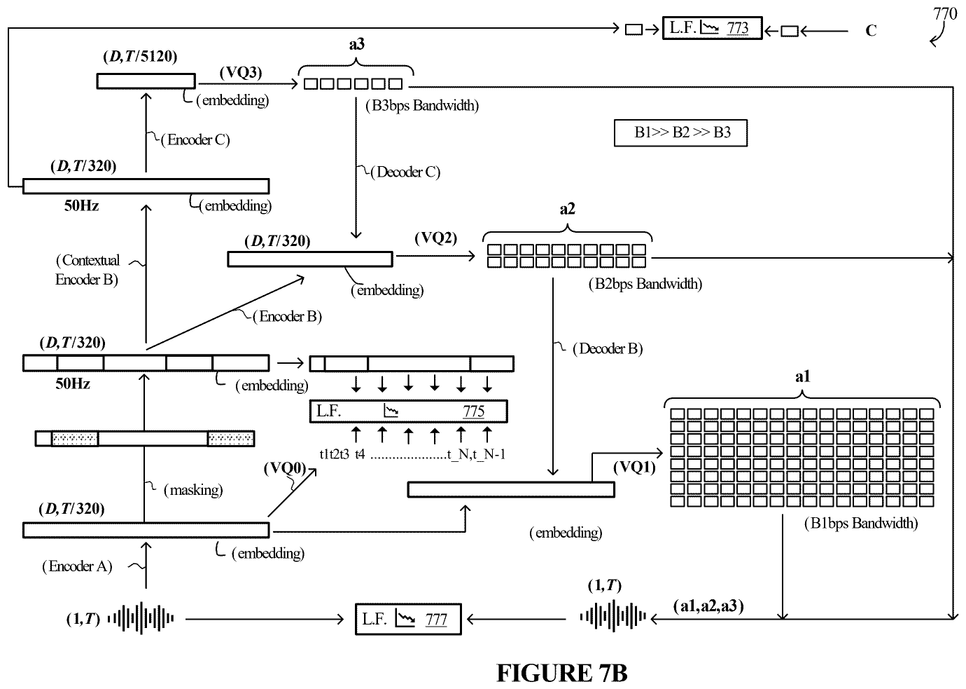

Turning now to the figures, FIG. 1 illustrates a hierarchical audio generator-or HAGen—represented by system 100 in an implementation, while FIG. 2 illustrates an audio generation process associated with system 100. FIG. 3 explains the training of such hierarchical audio generators using a hierarchical codec as described above, while FIG. 4 illustrates the training of such hierarchical codecs. FIG. 5 illustrates another hierarchical audio generator, while FIGS. 6A-6C illustrate the training thereof. Related, FIGS. 7A and 7B illustrate another hierarchical audio codec and the training thereof.

Referring to FIG. 1, system 100 includes various elements that function in a coupled or cooperative manner to generate audio based on context. That is, system 100 is of a class of systems referred to as generative artificial intelligence because it can generate new content such as the aforementioned audio. Indeed, while the present disclosure generally pertains to generative audio content, it may be appreciated that the inventive concepts may apply as well to other content formats such as video, text, images, and the like.

Generally speaking, system 100 takes context data as input, processes the context data to generate audio, and outputs the audio. For example, a text string indicative of semantic musical genre, acoustic scene, or other such semantic context may be supplied as input to system 100. Seeded with the desired context, system 100 generates audio having features that capture the desired context at multiple levels of abstraction in abstraction hierarchy 105. The top level of the hierarchy is a semantic layer 108 that represents concepts such as genre and mode; the middle level of the hierarchy is a structural layer 107 that represents concepts such as rhythm patterns and phoneme segmentation; and the lowest layer of abstraction is the audio signal layer 106 that captures basic signal properties such as amplitude and spectral characteristics. The resulting audio is of a quality the delights the listener in its faithfulness to the desired context.

More specifically, system 100 includes-but is not limited to-code generator 110, code generator 120, code generator 130, and decoder 140. Code generator 110, which is operatively coupled with code generator 120, is capable of processing context data to generate a sequence of semantic tokens. Code generator 120, which is further coupled with code generator 130, is capable of processing the semantic tokens sequences to generate structural token sequences. Code generator 130, which is further coupled with decoder 140, is capable of processing the structural token sequences to generate audio signal code sequences. Decoder 140 is then capable of processing the audio signal code sequences to produce audio signal data.

The elements of system 100 may be implemented in software and/or firmware executed by the circuitry of one or more processing devices. The processing devices may be implemented on a single computing device or distributed across multiple computing devices. Alternatively, or in addition, some or all of the functionality provided by any of the elements of system 100 may be implemented entirely via application-specific integrated circuits or other such special purpose devices.

System 100 employs an audio generation process illustrated in FIG. 2 to produce generative audio from context data. Audio generation process 200 may be implemented in program instructions in the context of the software and/or firmware elements of system 100 such as code generator 110, code generator 120, code generator 130, and decoder 140. The program instructions, when executed by one or more processing devices of one or more suitable computing devices, direct the one or more computing devices to operate as follows, referring to the steps of FIG. 2 and in the singular to a computing device for the sake of clarity.

In operation, the computing device receives input comprised of context data (step 201). The context data may be, for example, a text string that indicates a genre, mood, or other such semantic feature of the desired generative audio. Alternatively, or in addition, the context may be derived or otherwise inferred from some other type of input such as a representative clip of sound, music, speech, or the like.

The computing device then generates a sequence of top-level codes (or tokens) based on the context data (step 203). The computing device may, for example, generate a semantic embedding based on the context data and then supply the semantic embedding data as input to a large language model or other such generative model capable of producing a sequence of tokens. The tokens may be referred to as semantic tokens or semantic codes because the model employed at this step is, in a sense, trained on semantic features of audio training data. The sequence of semantic tokens function to influence the audio that is ultimately produced to be semantically similar to or representative of the desired context.

Next, the computing device generates mid-level codes based on the top-level codes (step 205). That is, the sequence of semantic tokens generated in the previous step are supplied as input to this step. The sequence of tokens produced at this step are referred to as structural tokens because the model employed at this step is, in a sense, trained on structural features of the audio training data. Conditioning the generation of the structural tokens on the semantic tokens ensures that the structural tokens are coherently aligned with the desired context, which further influences the audio that is produced to be semantically aligned with the desired context.

The resulting mid-level codes are then processed by the computing device to produce low-level codes (step 207). That is, the sequence of structural tokens generated in the previous step are supplied as input to this step. The sequence of tokens produced at this step are referred to as audio signal tokens because the model employed at this step is, in a sense, trained on audio signal features of the audio training data. Conditioning the generation of the audio signal tokens on the structural tokens ensures that the audio-signal tokens are also coherently aligned with the desired context since the structural tokens are coherently aligned with the semantic tokens. In addition, the alignment of the audio-signal tokens with the structural and/or semantic tokens further influences the audio to be semantically aligned with the desired context.

The computing device decodes the top-level codes, mid-level codes, and low-level codes to produce audio data (step 209) and outputs the resulting audio. Decoding involves, for example, converting the tokens into digital values the represent audio waveforms. The resulting audio data may then be played out, saved, transferred, processed further, or the like.

Referring back to FIG. 1, the following describes a specific application of audio generation process 200 by the elements of system 100. In operation, code generator 110, when executed by the computing device, processes context data to encode one or more semantic elements of a desired audio composition in a semantic token sequence (a3 codes). The a3 codes correspond to the semantic layer 108 of abstraction hierarchy 105.

The semantic token sequence is passed from code generator 110 to code generator 120. Code generator 120 processes the semantic token sequence to encode one or more structural elements of the desired audio composition in a structural token sequence (a2 codes) disentangled from the semantic token sequence. The a2 codes correspond to the structural layer 107 of abstraction hierarchy 105.

Code generator 120 passes the structural token sequence to code generator 130. Code generator 130 processes the structural token sequence to encode one or more audio signal elements of the desired audio composition in an audio signal token sequence (a1 codes) disentangled from the structural token sequence. The a1 codes correspond to the audio signal layer 106 of the abstraction hierarchy.

Decoder 140 accepts the a1 codes, the a2 codes, and the a3 codes as input, and processes the codes to decode them into audio data. For example, decoder 140 may map or otherwise convert each token into a digital audio format that may be output to an audio system, device, or the like.

FIG. 3 illustrates another hierarchical audio generator (system 300) and a method of training the same. The method of training the code generators in system 300 is generally representative of a method suitable for training the code generators of system 300. In addition, the training method disclosed in FIG. 3 relies upon trained encoders, the training of which is disclosed in more detail with respect to system 400 in FIG. 4.

The elements of system 300 may be implemented in software and/or firmware executed by the circuitry of one or more processing devices. The processing devices may be implemented on a single computing device or distributed across multiple computing devices. Alternatively, or in addition, some or all of the functionality provided by any of the elements of system 300 may be implemented entirely via application-specific integrated circuits or other such special purpose devices.

System 300 includes code generator 310, code generator 320, and code generator 330. System 300 also includes three corresponding hierarchical audio encoders, represented by semantic encoder 313, structural encoder 323, and signal encoder 333, as well as three corresponding loss functions: loss function 315, loss function 325, and loss function 335.

Code generator 310 and semantic encoder 313 are each coupled with loss function 315, and both are capable of processing audio data to produce semantic tokens as output. Semantic encoder 313 is also operatively coupled with code generator 320 and structural encoder 323. Code generator 320 and structural encoder 323 are each coupled with loss function 325 and are both capable of processing semantic tokens as input to produce structural tokens as output. Structural encoder 323 is also operatively coupled with code generator 330 and signal encoder 333. Code generator 330 and signal encoder 333 are each operatively coupled with loss function 335 and are both capable of processing structural tokens to produce audio signal tokens.

In operation, each encoder functions to generate ground-truth token values that are compared to the tokens produced by a corresponding code generator. (While illustrated as occurring at the same time and/or close in time, it may be appreciated that the ground truth tokens produced by semantic encoder 313 may be produced ahead of time.) The resulting losses are used to train the code generators to produce accurate code sequences. For example, both code generator 310 and semantic encoder 313 process the same audio data as input. Semantic encoder 313 is representative of a model trained to output semantic tokens. Thus, semantic tokens sequence a3 output by semantic encoder 313 is considered a ground truth token sequence. Code generator 310 is representative of a generative model that predicts a sequence of tokens based on the audio data. Accordingly, code generator 310 outputs a predicted semantic code sequence a3′. Loss function 315 computes a loss value based on the difference between a3 and a3′, which is supplied as feedback to code generator 310. One or more parameters of code generator 310 may be changed based on the feedback such that the output of code generator 310 begins to approximate or otherwise match that of semantic encoder 313. In other words, code generator 310 learns from the feedback to generate semantic token sequences conditioned upon context data.

Since the semantic tokens produced by semantic encoder 313 are ground-truth values, they are also supplied as input to code generator 320 and structural encoder 323. Structural encoder 323 is representative of a model trained to output mid-level structural tokens. Thus, structural tokens sequence a2 output by structural encoder 323 is also considered a ground truth token sequence. Code generator 320 is representative of another generative model that predicts a sequence of tokens based on the semantic tokens produced by semantic encoder 313. Accordingly, code generator 320 predicts a mid-level structural code sequence a2′. Loss function 325 computes a loss value based on the difference between a2 and a2′, which is supplied as feedback to code generator 320. One or more parameters of code generator 320 may be changed based on the feedback such that the output of code generator 320 begins to approximate or otherwise match that of structural encoder 323. In other words, code generator 320 learns-based on the feedback-to produce structural token sequences condition upon the semantic token sequences produced by semantic encoder 313.

The structural tokens produced by structural encoder 323 are ground-truth values and as such, they are supplied as input to code generator 330 and signal encoder 333. Signal encoder 333 is representative of a model trained to output low-level audio signal tokens. Thus, structural token sequence al output by signal encoder 333 is also considered a ground truth token sequence. Code generator 330 is another generative model that predicts a sequence of tokens based on the structural tokens produced by signal encoder 333. Thus, code generator 330 predicts a low-level audio signal code sequence a1′. Loss function 335 computes a loss value based on the difference between a1 and a1′, which is supplied as feedback to code generator 330. One or more parameters of code generator 330 may be changed based on the feedback such that the output of code generator 330 begins to approximate or otherwise match that of encoder 3 #3. In other words, code generator 330 learns to produce audio signal token sequences condition upon the structural token sequences output by structural encoder 323.

FIG. 4 illustrates a hierarchical audio codec—or HACodec—represented by system 400, as well as a method of training the same. The method of training semantic encoder 413, structural encoder 423, and signal encoder 433 disclosed in FIG. 4 generally represents a method suitable for training the encoders of system 300, which are used to train the code generators of system 300. The elements of system 400 may be implemented in software and/or firmware executed by the circuitry of one or more processing devices. The processing devices may be implemented on a single computing device or distributed across multiple computing devices. Alternatively, or in addition, some or all of the functionality provided by any of the elements of system 400 may be implemented entirely via application-specific integrated circuits or other such special purpose devices.

System 400 includes semantic encoder 413, structural encoder 423, signal encoder 433, and decoder 440. System 400 also includes loss functions 415, 425, and 445, as well as training data 405. Semantic encoder 413 is operatively coupled with structural encoder 423 and decoder 440 and is capable of processing context data to produce top-level semantic tokens (a3 codes). Structural encoder 423 is further coupled with signal encoder 433 and decoder 440 and is capable of processing top-level semantic codes to produce mid-level structural tokens (a2 codes). Signal encoder 433 is also operatively coupled with decoder 440, in addition to structural encoder 423, and is capable of processing mid-level structural tokens to produce low-level audio signal tokens (a1 codes).

Loss function 415 is coupled with the output of semantic encoder 413 and is capable of computing a loss based on the semantic tokens predicted by semantic encoder 413 and ground-truth semantic token values in training data 405. Loss function 425 is coupled with the output of semantic encoder 413 and is capable of computing a loss based on the structural tokens predicted by structural encoder 423 and ground-truth semantic token values in training data 405. Loss function 445 is coupled with decoder 440 and is capable of computing a loss based on audio data generated by decoder 440 and ground-truth audio data in training data 405. The losses computed by loss functions 415, 425, and 445 provide feedback that influences the training of encoders 413, 423, and 433 respectively.

Training data 405 may include, for example, a collection of audio samples for which the context, semantic features, structural features, and low-level audio may be known or from which the same may be derived. For example, training data 405 may include audio clips comprised of low-level audio signal data. Training data 405 may further include label data that is annotated a-priori with descriptions of the context, semantic features, and structural features of each audio clip. Alternatively, or in addition, the audio signal data may be processed at the time of training to generate one or more of the context, semantic features, and structural features of any of the audio clips. Example audio clips include songs, speeches, conversations, and the like, as well as portions, combinations, and/or variations thereof. The audio clips may represent non-synthetic content such as recordings of songs, speeches, or conversations provided by human sources, as well as synthetic content produced by non-human sources, and/or any combination or variation thereof.

In operation, semantic encoder 413 takes context data as input, which may be sourced from training data 405, and processes the context data to produce top-level semantic tokens. The context data may be provided in an embedded format such as a semantic embedding produced by an embedding engine upstream from semantic encoder 413 such as embedding engine 412. Embedding engine 412 extracts a semantic embedding (C) from a multi-dimensional vector representation (V) of an audio snippet. In an example, the snippet may be audio data of 20 msec in length. The vector may be a 768-dimension vector that embedding engine 412 processes to produce a semantic embedding. Embedding engine 412 itself may be a multi-modal encoder trained by a pretrained text encoder to generate appropriate embeddings.

Semantic encoder 413 employs a vector quantization (VQ) model to map the semantic embedding of the context data to a token in a top-level VQ codebook. The token is the output of semantic encoder 413. Thus, for any given context data that is input to semantic encoder 413 (or a semantic embedding thereof), semantic encoder 413 outputs a semantic token. A sequence of semantic embeddings input to semantic encoder 413 therefore results in a sequence of corresponding semantic tokens-also referred to as a3′ codes.

The top-level semantic tokens produced by semantic encoder 413 are supplied as input to loss function 415. Loss function 415 computes a loss between a predicted semantic token (a3′) and a known semantic token (a3) provided in labeling data associated with the audio snippet. The computed loss may be provided as feedback to semantic encoder 413 to influence the training of the VQ model such that the model learns to output quantized embeddings that are the same as or close to the ground-truth token values.

The semantic tokens produced by semantic encoder 413 are also supplied as input to a residual embedding function 422. Residual embedding function 422 computes a difference between the multi-dimensional vector (V) and the semantic tokes (a3). The resulting top-level residual embedding is supplied as input to structural encoder 423.

Structural encoder 423 also employs a vector quantization (VQ) model to map top-level residual embedding to one or more tokens in one or more mid-level VQ codebooks. Thus, for any given top-level residual embedding that is input to structural encoder 423, structural encoder 423 outputs a mid-level structural token. A sequence of top-level residual embeddings input to structural encoder 423 therefore results in a sequence of corresponding mid-level structural tokens (a2′).

The mid-level semantic tokens produced by structural encoder 423 are supplied as input to loss function 425. Loss function 425 computes a loss between a predicated structural token (a2′) and a known structural token (a2) provided in labeling data associated with the audio snippet. The computed loss may be provided as feedback to structural encoder 423 to influence the training of the mid-level VQ model such that the model learns to output quantized embeddings that are the same as or close to the ground-truth token values.

The structural tokens produced by structural encoder 423 are also supplied as input to another residual embedding function 432. Residual embedding function 432 computes a difference between the top-level residual embeddings (V-a3′) produced by residual embedding function 422 and the structural tokens (a2′) produced by structural encoder 423. The resulting mid-level residual embedding is supplied as input to signal encoder 433.

Signal encoder 433 also employs a vector quantization (VQ) model to map mid-level residual embedding to one or more tokens in one or more low-level VQ codebooks. Thus, for any given mid-level residual embedding that is input to signal encoder 433, signal encoder 433 outputs a low-level structural token (a1′). A sequence of mid-level residual embeddings input to signal encoder 433 therefore results in a sequence of corresponding low-level audio signal tokens (a1′).

The resulting audio signal tokens are provided along with the semantic tokens and structural tokens to decoder 440. Decoder 440 converts the tokens from their tokenized values to digital audio values that may form audio wave forms or other such low-level audio signals. The low-level audio data is supplied as input to loss function 445. Loss function 445 computes a loss value based on the generated low-level audio data and ground-truth audio data supplied by training data 405. The computed loss may be provided as feedback to signal encoder 433 to influence the training of the low-level VQ model.

FIG. 5 illustrates system 500 in an implementation, which is representative of another hierarchical audio generator (or HAGen). System 500 includes code generator 510, code generator 520, code generator 530, and decoder 540. Code generator 510, which is operatively coupled with code generator 520, is capable of processing context data to generate a sequence of semantic tokens. Code generator 520, which is further coupled with code generator 530, is capable of processing the semantic tokens sequences to generate structural token sequences. Code generator 530, which is further coupled with decoder 540, is capable of processing the structural token sequences to generate audio signal code sequences. Decoder 540 is then capable of processing the audio signal code sequences to produce audio signal data.

The elements of system 500 may be implemented in software and/or firmware executed by the circuitry of one or more processing devices. The processing devices may be implemented on a single computing device or distributed across multiple computing devices. Alternatively, or in addition, some or all of the functionality provided by any of the elements of system 500 may be implemented entirely via application-specific integrated circuits or other such special purpose devices.

In operation, code generator 510 processes context data 501 to encode one or more semantic elements of a desired audio composition in a semantic token sequence 511 (a3 codes). The a3 codes correspond to a semantic layer of an abstraction hierarchy. The semantic token sequence is passed from code generator 510 to code generator 520. Code generator 520 processes the semantic token sequence to encode one or more structural elements of the desired audio composition in a structural token sequence 521 (a2 codes. The a2 codes correspond to a structural layer of the abstraction hierarchy.

Code generator 520 passes the structural token sequence to code generator 530. Code generator 530 processes the structural token sequence to encode one or more audio signal elements of the desired audio composition in an audio signal token sequence 531 (a1 codes). The a1 codes correspond to an audio signal layer of the abstraction hierarchy.

Decoder 540 accepts the a1 codes, the a2 codes, and the a3 codes as input, and processes the codes to decode them into audio data. For example, decoder 540 may map or otherwise convert each token into a digital audio format that may be output to an audio system, device, or the like.

FIG. 6A illustrates a training process 601 for training a top-level code generator conditioned on context 613 such as code generator 510 in FIG. 5. Training process 601 relates to code generator 610 which is representative of an autoregressive pre-trained text language model. Code generator 610 takes both the context embeddings 615 and top-level audio code embeddings 618 as input. The context embeddings are extracted from a pre-trained multimodal semantic encoder, while the top-level codes are obtained using an HACodec 660 such as those described earlier. The two embedding sequences are separated by a special token (SPL). The model is trained on the task of predicting future tokens based on past inputs, a training task commonly known as “next token prediction.” This approach ensures that the model learns to generate coherent and contextually appropriate top-level audio codes.

FIG. 6B illustrates a training process 602 for training a mid-level code generator such as code generator 520 in FIG. 5. Training process 602 relates to code generator 620 which is also representative of an autoregressive pre-trained text language model. The input to the code generator 620 includes both the top-level codes 624 and mid-level codes 626 extracted using the HACodec 660, with the two sequences separated by a special token 625 (SPL). Code generator 620 is trained on the task of “next-token prediction.” Since the mid-level can have more than one codebook (two in the illustration), each time step includes two codes. These code sequences are flattened as shown before being used as input to the language model. This approach ensures the model learns to generate coherent mid-level codes based on the context provided by the top-level codes.

FIG. 6C illustrates a training process 603 for training a low-level code generator such as code generator 530 in FIG. 5. Training process 603 relates to code generator 630 which is also representative of an autoregressive pre-trained text language model. The input to code generator 630 includes the mid-level codes 634 and low-level codes 636 extracted using the HACodec 660. The two sequences are fed into the model, where they are processed to generate the next-token predictions, ensuring that the low-level code generator learns to produce accurate and contextually appropriate low-level audio codes. This hierarchical training approach ensures each layer builds upon the previous one, resulting in a robust and coherent audio generation system.

After training the code generators, they may be sampled from to generate audio. Given context C, the audio is generated in three steps: 1) The top-level codes are generated, given C; 2) mid-level codes are generated conditioned on the top-level codes; and 3) low-level codes are generated conditioned on the mid-level codes.

For example, with respect to code generator 610, context (C) is transformed into embeddings using a multimodal semantic encoder. Based on these context embeddings, the model (code generator 610) generates top-level codes in an autoregressive manner, producing one code at a time. Each generated code is conditioned on the context and all previously generated codes, ensuring that the sequence aligns coherently with the provided context.

Similarly, with respect to code generator 620, the model generates mid-level codes in an autoregressive manner, producing one code at a time. Each generated code is conditioned on top-level codes produced by code generator 610 and all previously generated codes. Code generator 630 also generates codes in an autoregressive manner, producing one code at a time. Each generated code is conditioned on mid-level codes produced by code generator 620 and all previously generated codes.

As was briefly described, a multimodal encoder may be employed to transform context (audio, text, or images) into an embedding sequence used to condition the top-level code generator. The multimodal encoder is also utilized in training the HACodec models. The multimodal encoder may be trained using a Student-Teacher learning framework, where the multimodal encoder acts as the student and a pre-trained text encoder serves as the teacher. The training involves optimizing a contrastive loss between the outputs of the multimodal encoder and the pre-trained text encoder, ensuring that the multimodal encoder learns to generate embeddings that align closely with those produced by the teacher model.

FIG. 7A illustrates an encoding process 700 in an implementation that is representative of a hierarchical audio codec such as HACodec 660 in FIGS. 6A-6C, the output of which is used to train the HAGen models. Encoding process 700 compresses audio into discrete codes at three levels of abstraction. The compression process begins by first extracting top level discrete semantic codes 703 (represented by a3 codes), followed by the extraction of mid-level discrete codes 705 (represented by a2 codes), and finally the extraction of low-level discrete codes 707 (represented by a1 codes).

Extracting a3 codes: The top-level codes a3 are extracted by a Vector Quantization (VQ) module 713 (VQ3). VQ3 is conditioned on only the input audio. This conditioning is provided by Encoder-C 715. The input 1D audio waveform 710 is transformed into a sequence of D dimensional vectors. The length of the feature sequence that is inputted to VQ3 is T/S, where T is the length of the input audio and S is a down sampling factor (e.g., 5120). VQ refers to the process of mapping the above feature vectors to their nearest codebook entries.

Extracting a2 codes: The mid-level codes a2 are extracted by the VQ module 717 (VQ2). VQ2 is conditioned on both the input audio and the top-level codes a3 extracted above. The input audio conditioning is provided by the Encoder-B 719, and a3 conditioning is provided by the Decoder-C 721.

Extracting al codes: The low-level codes are extracted by the VQ module 723 (VQ1) which is conditioned on the input audio and the mid-level codes a2. Input audio conditioning is provided by Encoder-A 725, and conditioning on a2 is provided by the Decoder-B 727.

In some implementations, VQ3 may consist of a single codebook, while VQ2 may consist of two codebooks, and VQ3 may consist of 8 codebooks in the above illustration. A residual-VQ process may be employed to encode a feature vector with multiple codebooks.

Interpretation of Codes: The top-level codes encode high-level concepts such as genre of a musical piece, mood, grammar, syntax, meaning, sound event categories, and acoustic scene (indoor, outdoor, etc.). The mid-level codes encode information about musical instruments present in the audio recording, sound texture, beat, tempo, rhythm patterns, pitch contour, intonation, phoneme segmentation, event duration, event onset and offset, etc. The low-level codes extract basic signal properties such as amplitude, spectral and temporal characteristics.

FIG. 7B illustrates a tuning process 771 with respect to the hierarchical audio codec of FIG. 7A as well as HACodec 660 in FIGS. 6A-6C. Model tuning involves optimizing several loss functions. A top-level contrastive loss computed by loss function 773 between the audio embeddings and semantic embeddings, obtained by encoding the multimodal context with a semantic encoder, ensures that the top-level feature encoder learns semantic features, which are then fed into VQ3 for top-level semantic code extraction (a3). A mid-level masked-prediction loss computed by loss function 775 ensures that the mid-level discrete codes (a2) encode structural features such as those discussed earlier. Low-level signal matching losses computed by loss function 777 ensure that the low-level codes (a1) encode basic signal features. Through this training process, the HACodec compression models learn a hierarchical and disentangled representation of semantic, structural, and low-level discrete codes, effectively compressing audio data at different levels of abstraction.

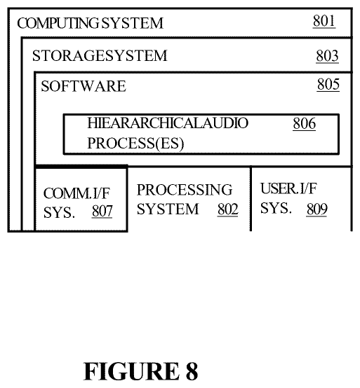

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, audio devices, and wearable devices (including headphones, ear buds, and the like). Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements hierarchical audio process(es) 806, which is representative of the audio processing methods and processes described above. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, digital signal processors, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including hierarchical audio process(es) 806) may be implemented in program instructions and among other functions may, when executed by processing system 802, direct processing system 802 to operate as described with respect to the various operational scenarios, sequences, and processes illustrated herein. For example, software 805 may include program instructions for implementing the inference and training processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to perform audio generation and/or audio encoding in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. An audio generation method, wherein the method uses a processor coupled with stored instructions implementing the method, wherein the instructions, when executed by the processor, carry out steps of the method, comprising:
executing a first code generator to generate, based on context data, a semantic token sequence having one or more semantic elements of a desired audio composition encoded therein;
executing a second code generator to generate, based on the semantic token sequence, a structural token sequence disentangled from the semantic token sequence and having one or more structural elements of the desired audio composition encoded therein;
executing a third code generator to generate, based on the structural token sequence, an audio signal token sequence disentangled from the structural token sequence and having one or more audio signal elements of the desired audio composition encoded therein; and
executing a decoder to obtain, based on the semantic token sequence, the structural token sequence, and the audio signal token sequence, at least a portion of the desired audio composition.

2. The audio generation method of claim 1 further comprising:
training the first code generator using a first encoder trained to generate semantic tokens based on audio data;
training the second code generator using a second encoder trained to generate structural tokens disentangled from the semantic tokens; and
training the third code generator using a third encoder trained to generate audio signal tokens disentangled from the semantic tokens and the structural tokens.

3. The audio generation method of claim 2 further comprising training the first encoder by at least: processing the audio data to generate semantic embeddings;
executing the first encoder to map the semantic embeddings to semantic tokens; and
computing first losses based on the semantic embeddings and ground-truth semantic embeddings known for an audio segment.

4. The audio generation method of claim 3 further comprising:
updating parameters of the first code generator based on the first losses; and
generating first residual embeddings based on differences between the semantic embeddings and the semantic tokens.

5. The audio generation method of claim 4 wherein training the first code generator using the first encoder comprises:
executing the first encoder to obtain first training data, wherein the first training data comprises a first sequence of semantic tokens;
executing the first code generator to obtain first predicted data, wherein the first predicted data comprises a first sequence of predicted semantic tokens;
computing a first loss based on the first sequence of semantic tokens and the first sequence of predicted semantic tokens; and
updating parameters of the first code generator based on the first loss.

6. The audio generation method of claim 4 further comprising training the second encoder by at least:
processing the first residual embeddings to generate structural tokens; and
computing second losses based on the structural tokens and ground-truth structural tokens known for the audio segment.

7. The audio generation method of claim 6 further comprising updating parameters of the second code generator based on the second losses.

8. The audio generation method of claim 7 wherein training the second code generator using the second encoder comprises:
executing the second encoder to obtain second training data, wherein the second training data comprises a sequence of structural tokens;
executing the second code generator to obtain second predicted data, wherein the second predicted data comprises a sequence of predicted structural tokens;
computing a second loss based on the sequence of structural tokens and the sequence of predicted structural tokens; and
updating parameters of the second code generator based on the second loss.

9. The audio generation method of claim 7 further comprising training the third encoder by at least:
processing second residual embeddings to generate audio signal tokens; and
generating audio signal data based at least on the audio signal tokens.

10. The audio generation method of claim 9 further comprising:
computing third losses based on the audio signal data and known audio signal data for the audio segment; and
updating parameters of the third code generator based on the third losses.

11. The audio generation method of claim 10 wherein training the third code generator using the third encoder comprises:
executing the third encoder to obtain third training data, wherein the third training data comprises a sequence of audio signal tokens;
executing the third code generator to obtain third predicted data, wherein the third predicted data comprises a sequence of predicted audio signal tokens;
computing a third loss based on the sequence of audio signal tokens and the sequence of predicted audio signal tokens; and
updating parameters of the third code generator based on the third loss.

12. The audio generation method of claim 1 wherein the one or more semantic elements of the desired audio composition comprise one or more of genre, instrument, key, mood, meaning, a sound event category, and an acoustic scene.

13. The audio generation method of claim 1 wherein the one or more structural elements of the desired audio composition comprise one or more of sound texture, beat, tempo, rhythm pattern, pitch contour, scale, chord progression, and song structure.

14. The audio generation method of claim 1 wherein the one or more structural elements of the desired audio composition comprise grammar, syntax, speaker identity, intonation, stress, prosody, emphasis, speech rate, pauses, silences, word segmentation, phoneme segmentation, and articulatory features.

15. The audio generation method of claim 1 wherein the one or more structural elements of the desired audio composition comprise event duration, event onset and offset, event patterns, and spatial features.

16. The audio generation method of claim 1 wherein the one or more audio signal elements of the desired audio composition comprise amplitude characteristics, spectral characteristics, and temporal characteristics.

17. The audio generation method of claim 1 wherein each token sequence, of the semantic token sequence, the structural token sequence, and the audio signal token sequence, comprises a disentangled token sequence with respect to each other token sequence of the semantic token sequence, the structural token sequence, and the audio signal token sequence.

18. A memory having program instructions stored thereon for processing audio, wherein the instructions, when executed by one or more processors of a computing device, direct the computing device to at least:
execute a first code generator to generate, based on context data, a semantic token sequence having one or more semantic elements of a desired audio composition encoded therein;
execute a second code generator to generate, based on the semantic token sequence, a structural token sequence disentangled from the semantic token sequence and having one or more structural elements of the desired audio composition encoded therein;
execute a third code generator to generate, based on the structural token sequence, an audio signal token sequence disentangled from the structural token sequence and having one or more audio signal elements of the desired audio composition encoded therein; and
execute a decoder to obtain, based on the semantic token sequence, the structural token sequence, and the audio signal token sequence, at least a portion of the desired audio composition.

19. The memory of claim 18 wherein the instructions, when executed by the one or more processors, further direct the computing device to at least:
train the first code generator using a first encoder trained to generate semantic tokens based on audio data;
train the second code generator using a second encoder trained to generate structural tokens disentangled from the semantic tokens; and
train the third code generator using a third encoder trained to generate audio signal tokens disentangled from the semantic tokens and the structural tokens.

20. A computing device comprising:
one or more computer readable storage media;
one or more processors operatively coupled with the one or more computer readable storage media; and
program instructions stored on the one or more computer readable storage media that, when executed by the one or more processors, direct the computing device to at least:
generate, based on context data, a semantic token sequence having one or more semantic elements of a desired audio composition encoded therein;
generate, based on the semantic token sequence, a structural token sequence disentangled from the semantic token sequence and having one or more structural elements of the desired audio composition encoded therein;
generate, based on the structural token sequence, an audio signal token sequence disentangled from the structural token sequence and having one or more audio signal elements of the desired audio composition encoded therein; and
obtain, based on the semantic token sequence, the structural token sequence, and the audio signal token sequence, at least a portion of the desired audio composition.
